(19) United States
(12) Patent Application Publication
(10) Pub. No.: US 2025/0388720 A1
(43) Pub. Date: Dec. 25, 2025

(54) ALKYD EMULSION HAVING IMPROVED WATER RESISTANCE AND IMPROVED HARDNESS DEVELOPMENT

(71) Applicant: Arkema France, Colombes (FR)

(72) Inventors: Alain RIONDEL, Verneuil En Halatte (FR); Emilie HARLAY, Verneuil En Halatte (FR); Michael KURCZAK, Verneuil En Halatte (FR)

(21) Appl. No.: 18/880,601

(22) PCT Filed: Jul. 5, 2023
(86) PCT No.: PCT/EP2023/068497

§ 371 Date: Jan. 2, 2025

(30) Foreign Application Priority Data
Jul. 5, 2022 (FR) FR22.06800

(51) Int. Cl. C08G 63/48; C08J 3/05; C09D 5/02; C09D 167/08; C09J 167/08

(52) U.S. Cl. CPC C08G 63/48; C08J 3/05; C09D 5/024; C09D 167/08; C09J 167/08; C08J 2367/08

(57) ABSTRACT

The present invention relates to an alkyd emulsion comprising an alkyd resin based on a conjugated fatty acid and also a reactive surfactant. The invention also covers a process for the preparation of the alkyd emulsion and its use in decorative coatings. The coating obtained with this alkyd emulsion exhibits improved performance qualities in terms of water resistance and of hardness development.

### TECHNICAL FIELD

The present invention relates to an alkyd emulsion comprising an alkyd resin based on a conjugated fatty acid and also a reactive surfactant. The invention also covers a process for the preparation of the alkyd emulsion and its use in decorative coatings. The coating obtained with this alkyd emulsion exhibits improved performance qualities in terms of water resistance and of hardness development.

### PRIOR ART

Polyester resins are obtained by reacting polyacids and polyols. Polyester resins can be modified by addition of a fatty component, in particular an oil or a fatty acid, to form a particular type of polyester resin: alkyd resins. Alkyd resins have been used for more than 50 years to form coatings, in particular decorative and industrial paints.

The presence of a fatty component in alkyd resins gives flexibility and gloss to the coating obtained. When the fatty component includes unsaturations, the alkyds can dry by autoxidation (addition of a drier).

Alkyd resins in an organic solvent medium, also called solvent-based alkyd resins, have been known for a long time to a person skilled in the art and are generally used in decorative and industrial paint formulations and coatings. To respond to issues of comfort of use, of odor and of toxicity related to the use of volatile organic compounds (VOCs), alkyd emulsions have been developed and marketed for approximately twenty years, with advantageous performance levels in terms of gloss, of drying, of appearance/color, of stability and of odor.

Alkyd emulsions, also called post-emulsified alkyd resins, can be obtained by emulsifying an alkyd resin by addition of a surfactant and of water. For example, the patent application WO 2018/029407 A1 describes an alkyd emulsion based on a conjugated acid. The application WO 2018/092158 describes an alkyd emulsion with a reactive surfactant. However, the performance qualities of these alkyd emulsions, in particular in terms of water resistance and of hardness development, remain inferior to those of solvent-based alkyd resins.

There exists a need for an alkyd emulsion having excellent water resistance and good hardness development while maintaining good applicative properties, in particular in terms of gloss, adhesion to substrate, flexibility, abrasion resistance, resistance to self-adhesion (blocking), mechanical strength, drying, appearance/color, stability and odor.

Surprisingly, the applicant company has discovered that the combined use of an alkyd resin based on a conjugated acid and of a reactive surfactant makes it possible to simultaneously improve the water resistance and the hardness development of the coating obtained from the alkyd emulsion. Without wishing to be committed to any one theory, the applicant company imagines that the formation of a ring by a Diels-Alder reaction between the conjugated acid and the reactive surfactant might be the cause of the synergy observed.

### SUMMARY OF THE INVENTION

The subject matter of the present invention concerns an alkyd emulsion comprising:
a) an alkyd resin having an oil length of 20% to 50%, the alkyd resin being based on an acid component A and on an alcohol component B, the acid component A comprising a conjugated fatty acid component A1, the component A1 representing at least 5%, preferably from 5% to 40%, more preferentially from 10% to 35%, of the total weight of the components A and B;
b) a surfactant comprising a reactive surfactant, preferably an ethylenically unsaturated surfactant;
c) water.

The invention also relates to a process for the preparation of an emulsion according to the invention, the process comprising the following stages:
i) preparation of a component a) comprising an alkyd resin in the molten state;
ii) addition of a component b) comprising a reactive surfactant and water,
iii) neutralization of the acidity of the components a) and b) by addition of a base,
iv) emulsification by phase inversion,
v) optionally adjustment of the solids content of the alkyd emulsion.

The invention also relates to a composition comprising an alkyd emulsion according to the invention.

The invention also relates to the use of the alkyd emulsion according to the invention as binder for obtaining a coating, an adhesive or a mastic, in particular for obtaining a coating, more particularly for obtaining a film, a paint, a varnish, a lacquer, a stain, an adhesion primer or an ink.

The invention also relates to a coating, an adhesive or a mastic obtained by application and drying of the composition according to the invention.

### DETAILED DESCRIPTION

### Definitions

In the present patent application, the terms “comprises a” and “comprises an” mean “comprises one or more”.

Unless otherwise mentioned, the percentages by weight in a compound or a composition are expressed with respect to the weight of the compound or of the composition.

Within the meaning of the present invention, an ethylenically unsaturated group is a group containing a polymerizable carbon-carbon double bond.

Within the meaning of the present invention, a polymerizable carbon-carbon double bond is a carbon-carbon double bond which can react with another carbon-carbon double bond in a polymerization reaction. A polymerizable carbon-carbon double bond is generally comprised in a group chosen from acrylate (including cyanoacrylate), methacrylate, acrylamide, methacrylamide, styrene, maleate, fumarate, itaconate, allyl, propenyl, vinyl and corresponding combinations, preferably chosen from acrylate, methacrylate, allyl and vinyl. The carbon-carbon double bonds of an aromatic ring are not regarded as polymerizable carbon-carbon double bonds.

Within the meaning of the present invention, an alkyl group is a saturated monovalent acyclic group of formula —CₙH₂ₙ₊₁. An alkyl can be linear or branched. A C₁-C₆ alkyl means an alkyl comprising from 1 to 6 carbon atoms.

Within the meaning of the present invention, an alkenyl group is a monovalent acyclic group having one or more C═C double bonds. An alkenyl can be linear or branched.

Within the meaning of the present invention, an alkoxy group is a group of formula —O-alkyl.

Within the meaning of the present invention, an aryl group is a group containing at least one aromatic ring. An aryl can contain a single aromatic ring or several rings, at least one of which is aromatic. An aromatic ring corresponds to a ring which observes Hückel's rule. Examples of aryl groups are phenyl, biphenyl, naphthyl and anthracenyl. The aryl groups of the invention preferably comprise from 6 to 12 carbon atoms. More preferably still, the aryl group of the invention is a phenyl group.

Within the meaning of the present invention, an alkylaryl group is a group of formula -A-aryl in which A is an alkylene. Preferably, an alkylaryl is a group of formula —CR₂R₃-Ph and R₂ and R₅ are independently H or Me, more preferentially a group of formula —CH(CH₃)-Ph.

Within the meaning of the present invention, an alkylene group is a divalent aliphatic radical derived from an alkane of formula CₘH₂ₘ₊₂, with m=2 to 50, by removing a hydrogen atom at each point of attachment of the radical. An alkylene can be linear or branched. A C₂-C₄ alkylene means an alkylene comprising from 2 to 4 carbon atoms.

Within the meaning of the present invention, an oxyalkylene group is a group of formula —O-A- in which A is an alkylene.

Within the meaning of the present invention, a polyoxyalkylene group is a group of formula —O-[A-O]ₙ— in which each A is independently a C₂-C₄ alkylene, preferably ethylene or propylene, and n ranges from 1 to 100, from 2 to 60, from 3 to 50, from 4 to 40 or from 5 to 30.

Within the meaning of the present invention, an aliphatic group or compound is a nonaromatic acyclic group or compound. It can be linear or branched, saturated or unsaturated and substituted or unsubstituted. It can comprise one or more bonds/functions, for example chosen from ether, ester, amide, urethane, urea and their mixtures.

Within the meaning of the present invention, a cycloaliphatic group or compound is a nonaromatic group or compound comprising a ring. It can be substituted or unsubstituted. It can comprise one or more bonds/functions as defined for the term “aliphatic”.

Within the meaning of the present invention, an aromatic group or compound is a group or a compound comprising an aromatic ring, that is to say a ring observing Hückel's aromaticity rule, in particular a group or a compound comprising a phenyl group. It can be substituted or unsubstituted. It can comprise one or more bonds/functions as defined for the term “aliphatic”.

Within the meaning of the present invention, a saturated group or compound means a group or a compound which does not comprise a carbon-carbon double or triple bond.

Within the meaning of the present invention, an unsaturated group or compound means a group or a compound which comprises a carbon-carbon double or triple bond, in particular a carbon-carbon double bond.

Within the meaning of the present invention, a substituted group or compound is a group or a compound in which one or more hydrogen atoms have been replaced by a group or a function independently chosen from alkyl, hydroxyl (—OH), alkoxy, halogen (Br, Cl, I), cyano (—CN), isocyanate (—NCO), oxo (═O), amine (—NR₂), carboxylic acid (—COOH), ester (—COOR′), anhydride (—CO—O—COR′), sulfonyl (—S(═O)₂OR), phosphonyl (—P(═O)(OR″)₂), sulfate (—O—S(═O)₂OR″) and phosphate (—O—P(═O)(OR″)₂), each R being independently H or alkyl, each R′ being independently alkyl and each R″ being independently a hydrogen atom, a metal salt or a hydrocarbyl chain.

### Alkyd Emulsion

The invention relates first of all to an alkyd emulsion comprising an alkyd resin, a surfactant and water.

Within the meaning of the present invention, an emulsion corresponds to a liquid organic phase (noncontinuous phase) dispersed in the form of droplets in an aqueous phase (continuous phase), the droplets being stabilized by a surfactant. According to a particular embodiment, the alkyd emulsion is not in the form of a dispersion of a solid or semisolid organic phase in an aqueous phase; in other words, it is not in the form of a colloidal suspension or of a latex.

The aqueous phase is a liquid comprising water. This liquid can additionally comprise a solvent other than water, such as, for example, butyl glycol.

According to one embodiment, the alkyd emulsion comprises less than 10%, in particular less than 5%, more particularly less than 1%, more particularly still less than 0.1%, by weight of solvent other than water, with respect to the weight of the emulsion. Thus, the alkyd emulsion exhibits a low content of volatile organic compounds (VOCs), that is to say less than 10%, in particular less than 5%, more particularly less than 1%, more particularly still less than 0.1%, by weight of VOCs, with respect to the weight of the emulsion.

The liquid organic phase comprises an alkyd resin as described below. According to a particular embodiment, the alkyd resin is not self-emulsifiable, that is to say that it does not contain a sufficient amount of ionizable functional groups to spontaneously form an emulsion after addition of water with stirring. In other words, the presence of a surfactant is necessary to stabilize the alkyd emulsion according to the invention.

The surfactant can in particular be as described below.

According to one embodiment, the alkyd emulsion exhibits a content of solids (also called solids content) of 35% to 65%, in particular of 40% to 60%, more particularly of 45% to 55%, by weight. The solids content can be measured by the ISO 3251:2008 method.

The alkyd emulsion can in particular exhibit a pH of from 7 to 9, in particular from 7.5 to 8.5.

The viscosity of the alkyd emulsion can in particular range from 1 to 1000 mPa·s, in particular from 2 to 500 mPa's, more particularly from 5 to 100 mPa·s. The viscosity can be measured at 23° C. according to the measurement method described below.

The alkyd emulsion can in particular exhibit a mean size of the particles of from 50 to 1000 nm, in particular from 75 to 500 nm, more particularly from 100 to 300 nm. The mean size of the particles can correspond to the volume-average size measured by laser particle size analysis.

### Alkyd Resin

The alkyd emulsion according to the invention comprises an alkyd resin, also called component a).

The alkyd resin is based on an acid component A and on an alcohol component B. In other words, the alkyd resin is obtained by polycondensation of an acid component A and of an alcohol component B.

The acid component A comprises at least one acid. The acid component A can comprise a mixture of acids. Preferably, the acid component A consists of all the acids used to prepare the alkyd resin.

The alcohol component B comprises at least one alcohol. The alcohol component B can comprise a mixture of alcohols. Preferably, the alcohol component B contains all the alcohols used to prepare the alkyd resin.

Within the meaning of the present invention, the term “acid” means a compound comprising at least one carboxylic acid (—COOH) function or a function which can generate a carboxylic acid function in situ (in particular by hydrolysis). The term “acid” thus includes acid derivatives, such as anhydrides and esters. When the acid contains a single carboxylic acid function (or a single function which can generate a carboxylic acid function in situ), it is a monoacid. When the acid contains more than one carboxylic acid function (or more than one function which can generate a carboxylic acid function in situ), it is a polyacid.

Within the meaning of the present invention, the term “alcohol” means a compound comprising at least one hydroxyl (—OH) function. When the alcohol contains a single hydroxyl function, it is a monoalcohol. When the alcohol contains more than one hydroxyl function, it is a polyol.

The component A can in particular represent from 50% to 95%, especially from 60% to 90%, more particularly from 70% to 80%, of the total weight of the components A and B. In other words, the alkyd resin comprises from 50% to 95%, especially from 60% to 90%, more particularly from 70% to 80%, by weight of units derived from an acid, with respect to the total weight of the alkyd resin.

The component B can in particular represent from 5% to 50%, especially from 10% to 40%, more particularly from 20% to 30%, of the total weight of the components A and B. In other words, the alkyd resin comprises from 5% to 50%, especially from 10% to 40%, more particularly from 20% to 30%, by weight of units derived from an alcohol, with respect to the total weight of the alkyd resin.

In particular, the total weight of the components A and B represents the total weight of the alkyd resin.

The alkyd resin exhibits an oil length of 20% to 50%.

The oil length of an alkyd resin can in particular correspond to the % by weight of fatty component used to obtain the alkyd resin (or the % by weight of units derived from a fatty component), with respect to the total weight of the alkyd resin. The fatty component comprises in particular all the fatty acids used to prepare the alkyd resin.

Within the meaning of the present invention, the term “fatty acid” means an acid having a fatty chain, that is to say a (noncyclic) hydrocarbyl chain comprising from 10 to 60, in particular from 12 to 55, more particularly from 14 to 50, consecutive carbon atoms. A fatty acid can be saturated or unsaturated. A saturated fatty acid is a fatty acid which does not comprise a C═C double bond. An unsaturated fatty acid comprises at least one C═C double bond. A monounsaturated fatty acid contains a single C═C double bond. A polyunsaturated fatty acid contains more than one C═C double bond. The hydrocarbyl chain of the fatty acid can be substituted, in particular by one or more hydroxyl or carbonyl functions. The term “fatty acid” includes fatty acid derivatives, that is to say compounds which can generate a fatty acid in situ, in particular by hydrolysis, and also the compounds obtained by reaction between several fatty acids (in particular dimerization, trimerization, standolization, estolidation). Fatty acid derivatives include, in particular, fatty acid esters (in particular fatty acid alkyl esters and triglycerides or oils), stand oils, estolides and also fatty acid dimers and trimers.

The acid component A comprises a conjugated fatty acid component A1.

The component A1 comprises at least one conjugated fatty acid. The component A1 can comprise a mixture of conjugated fatty acids. In particular, the component A1 consists of all the conjugated fatty acids used to prepare the alkyd resin.

Within the meaning of the present invention, the term “conjugated fatty acid” means a polyunsaturated fatty acid comprising two C═C double bonds separated by a single C—C bond. A conjugated fatty acid can in particular result from the isomerization of a polyunsaturated fatty acid (in particular of natural origin, more particularly of vegetable or animal origin), such as linoleic acid, α-linolenic acid, y-linoleic acid, stearidonic acid, icosapentaenoic acid or docosahexaenoic acid. A conjugated fatty acid can also result from the dehydration of a hydroxylated unsaturated fatty acid (in particular of natural origin, more particularly of vegetable origin), such as ricinoleic acid.

Examples of conjugated fatty acids are 9,11-octadecadienoic acid, 10, 12-octadecadienoic acid, 8,10,12-octadecatrienoic acid, 9,11,13-octadecatrienoic acid, 9,11,15-octadecatrienoic acid, 9,13,15-octadecatrienoic acid, 6,9,11-octadecatrienoic acid, 10, 12, 14-octadecatrienoic acid, 9,11,13, 15-octadecatetraenoic acid, 10,12-nonadecadienoic acid, 5,7,9,14,17-icosapentaenoic acid and 5,8,10,12,14-icosapentaenoic acid. Preferably, the conjugated fatty acid is 9,11-octadecadienoic acid. The component A1 represents at least 5%, preferably from 5% to 40%, more preferentially from 10% to 35%, of the total weight of the components A and B. In other words, the alkyd resin comprises at least 5%, preferably from 5% to 40%, more preferentially from 10% to 35%, by weight of units derived from a conjugated fatty acid, with respect to the total weight of the alkyd resin.

The conjugated fatty acid can in particular be introduced in the form of a mixture of fatty acids comprising one or more conjugated fatty acids and also one or more fatty acids chosen from a saturated fatty acid, a monounsaturated fatty acid, a nonconjugated polyunsaturated fatty acid, and also the derivatives of these. Such mixtures can in particular result from an oil or fat of natural origin, in particular a vegetable or animal oil, such as castor oil, sunflower oil, linseed oil, soybean oil, tall oil, Chinese wood oil (tung oil), chia seed oil, perilla oil, poppy seed oil, cottonseed oil, lesquerella oil, safflower oil, oiticica oil, rapeseed oil, corn oil, calendula oil, hemp oil or fish oil. The oil can in particular be a vegetable oil modified by a dehydration and/or isomerization reaction to generate conjugated double bonds.

In particular, the conjugated fatty acid can result from a modified vegetable oil, preferably chosen from a dehydrated castor oil, an isomerized sunflower oil, an isomerized linseed oil or an isomerized soybean oil, more preferentially a dehydrated castor oil.

Examples of mixtures comprising a conjugated fatty acid are Nouracid® DE 656, DE 655, DE 554, DE 503, DE 402 or DZ 453 (dehydrated castor fatty acid—available from Oléon); Nouracid® HE 456, HE 306, HE 305, HE 304, HE 303 or HE 301 (isomerized sunflower fatty acid—available from Oléon); Nouracid® LE 805 (isomerized linseed fatty acid—available from Oléon); Nouracid® SE 305 (isomerized soybean fatty acid—available from Oléon); Dedico® 5981 (dehydrated castor fatty acid—available from Croda); isomergic acid SK, SY or SF (isomerized vegetable fatty acid—available from Hobum Oleochemicals GmbH), Pamolyn® 300, (isomerized tall oil fatty acid—available from Eastman).

The acid component A can comprise a polyacid component A2. The component A2 comprises at least one polyacid. The component A2 can comprise a mixture of polyacids. In particular, the component A2 consists of all the polyacids used to prepare the alkyd resin.

The polyacid can in particular be unsaturated or saturated, in particular saturated. The polyacid can in particular be chosen from a dicarboxylic acid, a tricarboxylic acid, a monocarboxylic acid dimer, a monocarboxylic acid trimer, a derivative of these, and also a mixture of these. The polyacid can in particular comprise from 3 to 54, especially from 4 to 20, more particularly from 5 to 15, carbon atoms. According to one embodiment, the polyacid is a saturated or unsaturated polyacid. According to one embodiment, the polyacid is an aliphatic, cycloaliphatic or aromatic, preferably aromatic, polyacid.

The polyacid can in particular have a functionality (number of carboxylic acid functions or carboxylic acid derivative functions) ranging from 2 to 4, in particular from 2 to 3, more particularly equal to 2.

Examples of saturated aliphatic polyacids are malonic acid, succinic acid, 2-methylsuccinic acid, 2,2-dimethylsuccinic acid, glutaric acid, 3,3-diethylglutaric acid, adipic acid, pimelic acid, suberic acid, azelaic acid, sebacic acid, dodecanedioic acid, citric acid, propane-1,2,3-tricarboxylic acid, a saturated C₃₂ to C₃₆ fatty acid dimer, a saturated C₅₄ fatty acid trimer and mixtures of these.

Examples of unsaturated aliphatic polyacids are itaconic acid, maleic acid, fumaric acid, glutaconic acid, muconic acid and mixtures of these.

An example of a saturated cycloaliphatic polyacid is cyclohexanedicarboxylic acid.

An example of an unsaturated cycloaliphatic polyacid is tetrahydrophthalic acid.

Examples of aromatic polyacids are phthalic acid, isophthalic acid, terephthalic acid, naphthalenedicarboxylic acid, trimellitic acid, 2,5-furandicarboxylic acid and mixtures of these.

The polyacid can be a polyacid derivative. Such a derivative can be transformed into polyacid by hydrolysis. The polyacid derivatives include the partially or completely esterified forms of the polyacids defined above, in particular the C₁-C₆ alkyl mono-, di- and triesters of the polyacids defined above, and also the cyclic anhydrides. The polyacid derivatives can in particular comprise from 5 to 60, in particular from 6 to 25, more particularly from 7 to 20, carbon atoms.

Examples of suitable polyacid derivatives of ester type are dimethyl malonate, diethyl malonate, dimethyl adipate, dimethyl glutarate and dimethyl succinate.

The polyacid derivative can in particular be a cyclic anhydride. The cyclic anhydride can be saturated or unsaturated, in particular unsaturated. The cyclic anhydride can be cycloaliphatic or aromatic, in particular aromatic.

Examples of saturated cyclic anhydrides are succinic anhydride and hexahydrophthalic anhydride. Examples of unsaturated cycloaliphatic anhydrides are maleic anhydride, fumaric anhydride and tetrahydrophthalic anhydride. An example of an aromatic anhydride is phthalic anhydride.

According to a preferred embodiment, the polyacid component A2 comprises a cyclic anhydride, more particularly an unsaturated cyclic anhydride, more particularly still an aromatic anhydride, in particular phthalic anhydride.

The component A2 represents from 0% to 50%, in particular from 10% to 45%, more particularly from 20% to 40%, of the total weight of the components A and B. In other words, the alkyd resin comprises from 0% to 50%, in particular from 10% to 45%, more particularly from 20% to 40%, by weight of units derived from a polyacid, with respect to the total weight of the alkyd resin.

The acid component A can comprise a nonfatty monoacid component A3. The component A3 comprises at least one nonfatty monoacid. The component A3 can comprise a mixture of nonfatty monoacids. In particular, the component A3 consists of all the nonfatty monoacids used to prepare the alkyd resin.

Within the meaning of the present invention, the term “nonfatty monoacid” means a C₂-C₉ monoacid, that is to say a monoacid having from 2 to 9 carbon atoms.

The nonfatty monoacid can be an aliphatic, cycloaliphatic or aromatic, in particular aromatic, monoacid.

Examples of suitable nonfatty monoacids are benzoic acid, tert-butylbenzoic acid, hexahydrobenzoic acid, caproic acid, caprylic acid, 2-ethylhexanoic acid and mixtures of these.

According to a particular embodiment, the component A3 comprises an aromatic nonfatty monoacid, more particularly benzoic acid.

The component A3 represents from 0% to 50%, in particular from 5% to 30%, more particularly from 10% to 20%, of the total weight of the components A and B. In other words, the alkyd resin comprises from 0% to 50%, in particular from 5% to 30%, more particularly from 10% to 20%, by weight of units derived from a nonfatty monoacid, with respect to the total weight of the alkyd resin.

The acid component A can comprise a saturated fatty acid component A4. The component A4 comprises at least one saturated fatty acid. The component A4 can comprise a mixture of saturated fatty acids. In particular, the component A4 consists of all the saturated fatty acids used to prepare the alkyd resin.

Examples of saturated fatty acids are capric acid, lauric acid, myristic acid, palmitic acid, stearic acid, 9-hydroxystearic acid, 10-hydroxystearic acid, 12-hydroxystearic acid, icosanoic acid, 14-hydroxyicosanoic acid and mixtures of these. The saturated fatty acid can in particular result from a palm oil, a coconut oil, a hydrogenated castor oil, an animal fat and their mixtures.

The component A4 represents from 0% to 20%, in particular from 0% to 10%, more particularly from 0% to 5%, of the total weight of the components A and B. In other words, the alkyd resin comprises from 0% to 20%, in particular from 0% to 10%, more particularly from 0% to 5%, by weight of units derived from a saturated fatty acid, with respect to the total weight of the alkyd resin.

The acid component A can comprise a monounsaturated fatty acid component A5. The component A5 comprises at least one monounsaturated fatty acid. The component A5 can comprise a mixture of monounsaturated fatty acids. In particular, the component A5 consists of all the monounsaturated fatty acids used to prepare the alkyd resin.

Examples of monounsaturated fatty acids are myristoleic acid, palmitoleic acid, sapienic acid, oleic acid, gadoleic acid, ricinoleic acid (12-hydroxy-9-octadecenoic acid), elaidic acid, trans-vaccenic acid, erucic acid, nervonic acid, brassidic acid, lesquerolic acid (14-hydroxy-11-icosenoic acid) and mixtures of these.

The monounsaturated fatty monoacid can in particular result from a vegetable oil as described above.

The component A5 represents from 0% to 20%, in particular from 1% to 10%, more particularly from 2% to 8%, of the total weight of the components A and B. In other words, the alkyd resin comprises from 0% to 20%, in particular from 1% to 10%, more particularly from 2% to 8%, by weight of units derived from a monounsaturated fatty acid, with respect to the total weight of the alkyd resin.

The acid component A can comprise a nonconjugated polyunsaturated fatty acid component A6. The component A6 comprises at least one nonconjugated polyunsaturated fatty acid. The component A6 can comprise a mixture of nonconjugated polyunsaturated fatty acids. In particular, the component A6 consists of all the nonconjugated polyunsaturated fatty acids used to prepare the alkyd resin.

Examples of nonconjugated polyunsaturated fatty acids are fatty acids of 0-3 and 0-6 type, such as in particular 7,10,13-hexadecatrienoic acid, 9,12,15-octadecatrienoic acid, 6,9,12, 15-octadecatetraenoic acid, 11,14,17-icosatrienoic acid, 8,11,14, 17-icosatetraenoic acid, 5,8,11,14,17-icosapentaenoic acid, 6,9,12,15,18-heneicosapentaenoic acid, 7,10,13,16,19-docosapentaenoic acid, 4,7,10, 13,16, 19-docosahexaenoic acid, 9,12, 15, 18,21-tetracosapentaenoic acid, 6,9,12,15,18,21-tetracosahexaenoic acid, 9,12-octadecadienoic acid, 6,9,12-octadecatrienoic acid, 11,14-icosadienoic acid, 8,11,14-icosatrienoic acid, 5,8,11,14-icosatetraenoic acid, 13,16-docosadienoic acid, 7,10,13,16-docosatetraenoic acid, 4,7,10,13,16-docosapentaenoic acid, 9,12,15,18-tetracosatetraenoic acid, 6,9, 12, 15, 18-tetracosapentaenoic acid and mixtures of these.

The polyunsaturated fatty acid can in particular result from a vegetable oil as described for the conjugated fatty acid (preferably without modification, such as isomerization). Preferably, the nonconjugated polyunsaturated fatty acid results from a vegetable oil chosen from soybean oil, sunflower oil or tall oil.

The component A6 represents from 0% to 50%, in particular from 1% to 30%, more particularly from 5% to 20%, of the total weight of the components A and B. In other words, the alkyd resin comprises from 0% to 50%, in particular from 1% to 30%, more particularly from 5% to 20%, by weight of units derived from a nonconjugated polyunsaturated fatty acid, with respect to the total weight of the alkyd resin.

The alcohol component B can comprise a polyol component B1. The component B1 comprises at least one polyol. The component B1 can comprise a mixture of polyols. In particular, the component B1 consists of all the polyols used to prepare the alkyd resin.

The polyol can in particular have a functionality (number of hydroxyl functions) ranging from 2 to 6, in particular from 3 to 6, more particularly equal to 4.

The polyol can in particular be an aliphatic, cycloaliphatic or aromatic, especially aliphatic or cycloaliphatic, polyol. The polyol can in particular be a saturated polyol. Preferably, the polyol is a saturated aliphatic polyol.

According to one embodiment, the polyol has a molar mass of less than 400 g/mol, of less than 350 g/mol, of less than 300 g/mol, of less than 250 g/mol, of less than 200 g/mol or of less than 150 g/mol.

Examples of suitable polyols are ethylene glycol, 1,2-propanediol, 1,3-propanediol, 1,4-butanediol, 1,3-butanediol, 1,5-pentanediol, 1,6-hexanediol, 3-methyl-1,5-pentanediol, 1,10-decanediol, 1,12-dodecanediol, diethylene glycol, triethylene glycol, dipropylene glycol, tripropylene glycol, polyalkylene glycols, such as polyethylene glycol or polypropylene glycol (preferably with a number-average molecular weight Mn, calculated from the OH number, ranging from 250 to 3000 g/mol), 1,4-cyclohexanedimethanol, 1,6-cyclohexanedimethanol, 1,4-cyclohexanediol, bisphenol A, hydrogenated bisphenol A, glycerol, diglycerol, tricyclodecanedimethanol, trimethylolpropane, di (trimethylolpropane), trimethylolethane, 1,2,6-hexanetriol, 1,2,4-butanetriol, erythritol, pentaerythritol, di (pentaerythritol), neopentyl glycol, 2-butyl-2-ethyl-1,3-propanediol, 2-methyl-1,3-propanediol, 2-methyl-1,2-propanediol, sorbitol, mannitol, xylitol, isosorbide, isoidide, isomannide, methyl glucoside, polyester polyols (in particular polycaprolactone polyol), polycarbonate polyols, polyorganosiloxane polyols (in particular polydimethysiloxane polyol), polyglycerols, such as glycerol oligomers, for example Polyglycerol-3 (glycerol trimer) and decaglycerol, a hydroxy-terminated polybutadiene, a diol derived from a hydrogenated or nonhydrogenated fatty acid dimer or trimer, alkoxylated (in particular ethoxylated and/or propoxylated) derivatives of the abovementioned polyols, and mixtures of these.

According to a particular embodiment, the component B1 comprises a saturated aliphatic polyol chosen from trimethylolethane, trimethylolpropane, glycerol, di (trimethylolpropane), pentaerythritol, dipentaerythritol, a polyglycerol, sorbitol, a diol derived from a hydrogenated or nonhydrogenated fatty acid dimer or trimer, the alkoxylated (in particular ethoxylated and/or propoxylated) derivatives of the abovementioned polyols, and mixtures of these.

The component B1 represents from 0% to 50%, in particular from 10% to 40%, more particularly from 20% to 30%, of the total weight of the components A and B. In other words, the alkyd resin comprises from 0% to 50%, in particular from 10% to 40%, more particularly from 20% to 30%, by weight of units derived from a polyol, with respect to the total weight of the alkyd resin.

The alcohol component B can comprise a monoalcohol component B2. The component B2 comprises at least one monoalcohol. The component B2 can comprise a mixture of monoalcohols. In particular, the component B2 consists of all the monoalcohols used to prepare the alkyd resin.

The monoalcohol can in particular be an aliphatic, cycloaliphatic or aromatic, especially aliphatic or cycloaliphatic, monoalcohol. The monoalcohol can in particular be a saturated monoalcohol. Preferably, the monoalcohol is a saturated aliphatic monoalcohol.

The monoalcohol can in particular be a C₆-C₆₀, in particular C₈-C₅₅, more particularly C₁₀-C₅₀, monoalcohol.

Examples of suitable monoalcohols are octan-1-ol, octan-2-ol, 2-ethyl-1-hexanol, nonan-1-ol, decan-1-ol, undecan-1-ol, lauryl alcohol, myristyl alcohol, cetyl alcohol, stearyl alcohol, docosanol, the alkoxylated (in particular ethoxylated and/or propoxylated) derivatives of the abovementioned monoalcohols, and mixtures of these.

The component B2 represents from 0% to 20%, in particular from 0% to 10%, more particularly from 0% to 5%, of the total weight of the components A and B. In other words, the alkyd resin comprises from 0% to 20%, in particular from 0% to 10%, more particularly from 0% to 5%, by weight of units derived from a monoalcohol, with respect to the total weight of the alkyd resin.

The alkyd resin can in particular have a number-average molecular weight Mn ranging from 2500 to 6000 g/mol, in particular from 3500 to 5000 g/mol. The number-average molecular weight can in particular be measured by GPC in THE as polystyrene equivalents.

The acid number of the alkyd resin can in particular be less than 25 KOH/g, preferably from 5 to 20 mg KOH/g, more preferentially from 8 to 13 mg KOH/g.

The hydroxyl number of the alkyd resin can in particular be from 20 to 150 mg KOH/g, preferably from 30 to 100 mg KOH/g.

The alkyd resin can in particular have a mean functionality f ranging from 1.9 to 2.1. This mean functionality is defined according to the following relationship:

$$f = 2 {\sum }_{i} {n}_{i} {f}_{i} / {\sum }_{i} {n}_{i}$$

with nᵢ and fᵢ respectively being the number of moles and functionality of the acid or alcohol component i (mean over all of the reactive acid and alcohol components).

The alkyd resin can in particular have a Noury viscosity at 110° C. according to the AFNOR XPT51213 method ranging from 7000 to 13 000 mPa·s, preferably from 9000 to 12 000 mPa·s.

The content by weight of the component a), with respect to the weight of the alkyd emulsion, can range from 35% to 65%, in particular from 40% to 60%, more particularly from 45% to 55%.

### Surfactant

The alkyd emulsion according to the invention comprises a surfactant component, also called component b).

The component b) comprises a reactive surfactant. The component b) can comprise a mixture of reactive surfactants. The component b) can additionally comprise a nonreactive surfactant.

Within the meaning of the present invention, a surfactant is an amphiphilic compound (that is to say, having both a hydrophilic part and a hydrophobic part). The surfactant must in particular be able to stabilize the alkyd resin in the form of droplets dispersed in water. In particular, a surfactant suitable for forming an oil-in-water emulsion can have a value of the hydrophilic-lipophilic balance (HLB) of greater than 8, in particular of greater than 10, more particularly of greater than 12.

Within the meaning of the present invention, a reactive surfactant corresponds to a surfactant comprising a functional group capable of reacting with a functional group of the alkyd resin. Thus, a reactive surfactant can be directly incorporated in the backbone formed by the alkyd resin (in particular by a covalent bond). Preferably, the reactive surfactant is an ethylenically unsaturated surfactant.

Within the meaning of the invention, an “ethylenically unsaturated surfactant” means a compound which comprises a polymerizable carbon-carbon double bond.

According to a particular embodiment, the component b) comprises an anionic reactive surfactant. In particular, the anionic reactive surfactant can be a reactive surfactant based on phosphate, on phosphonate, on sulfate, on sulfonate, on sulfosuccinate or on carboxylate, more particularly a sulfate-based reactive surfactant.

The anionic reactive surfactant can comprise an aromatic ring. In particular, the anionic reactive surfactant can comprise a carbon-carbon double bond in the α or β position of the aromatic ring, more particularly in the α position of the aromatic ring.

The anionic reactive surfactant can in particular correspond to the following formula (Ia):

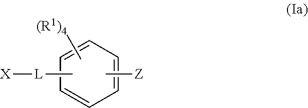

in which:
Z is an ethylenically unsaturated group, preferably a group of formula —CH═CH₂, —CH═CHCH₃ or —CH₂—CH═CH₂;
each R¹ is independently chosen from H, alkyl, alkenyl, alkoxy, aryl and alkylaryl; L is a bond, an alkylene, an oxyalkylene or a polyoxyalkylene;
X comprises a hydrophilic group, preferably chosen from —SO₃M, —CO₂M, —P(Y)O₂M, —C(═O)—CH(SO₃M)-CH₂—C(═O)—Y or —C(═O)—CH₂—CH(SO₃M)-C(═O)—Y, more preferentially-SO₃M;
M is H, a metal cation (in particular sodium or potassium) or an ammonium;
Y is OM or a residue of following formula (Ib):

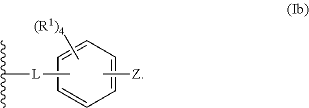

The anionic reactive surfactant can in particular correspond to the following formula (Ic):

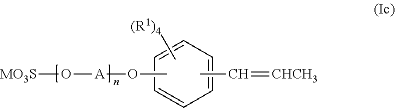

in which R¹ and M are as defined above;
each A is independently a C₂-C₄ alkylene, preferably ethylene or propylene;
n ranges from 1 to 100, from 2 to 60, from 3 to 50, from 4 to 40 or from 5 to 30.

The anionic reactive surfactant can in particular correspond to the following formula (Id):

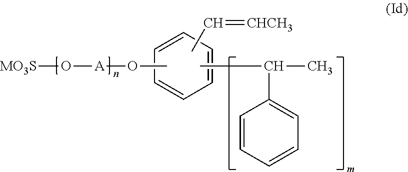

in which A, M and n are as defined above;
m is 1 or 2.

Examples of suitable anionic reactive surfactants are available under the references Hitenol® BC-3025, Hitenol® AR-1025, Hitenol® AR-10, Hitenol® KH-1025, Hitenol® KH-10, Hitenol® KH-05, Hitenol® BC-20, Hitenol® BC-1025 and Hitenol® BC-20 from Dai-Ichi Kogyo Seiyaku.

The content by weight of the anionic reactive surfactant, with respect to the weight of the alkyd emulsion, can range from 0% to 5%, preferably from 1% to 4% and more preferentially from 2% to 3%.

According to a particular embodiment, the component b) can comprise a nonionic reactive surfactant. In particular, the nonionic reactive surfactant can be a reactive surfactant based on a polyether.

The nonionic reactive surfactant can comprise an aromatic ring. In particular, the nonionic reactive surfactant can comprise a carbon-carbon double bond in the α or β position of the aromatic ring, more particularly in the α position of the aromatic ring.

The nonionic reactive surfactant can in particular correspond to the following formula (IIa):

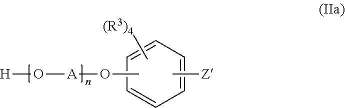

in which:
Z′ is an ethylenically unsaturated group, preferably a group of formula —CH═CH₂, —CH═CHCH₃ or —CH₂—CH═CH₂;
each R³ is independently chosen from H, alkyl, alkenyl, alkoxy, aryl and alkylaryl;
each A is independently a C₂-C₄ alkylene, preferably ethylene or propylene;
n ranges from 1 to 100, from 2 to 60, from 3 to 50, from 4 to 40 or from 5 to 30.

The nonionic reactive surfactant can in particular correspond to the following formula (IIb):

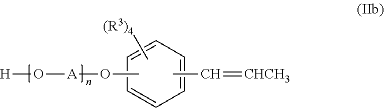

in which R₃, A and n are as defined above.

The nonionic reactive surfactant can in particular correspond to the following formula (IIc):

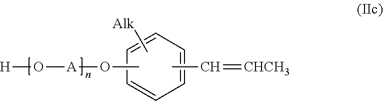

in which A and n are as defined above;
Alk is an alkyl, preferably a C₆-C₃₀ alkyl.

The nonionic reactive surfactant can be an aliphatic surfactant.

The nonionic reactive surfactant can in particular correspond to the following formula (Illa):

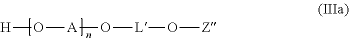

in which:
L′ is a C₅-C₃₀ alkylene which is preferably branched;
Z″ is an ethylenically unsaturated group, preferably a group of formula —C(═O)—CR₄=CH₂ or —CH₂—CR₅═CH₂;
R₄ and R⁵ are independently chosen from H and methyl;
each A is independently a C₂-C₄ alkylene, preferably ethylene or propylene;
n ranges from 1 to 100, from 2 to 60, from 3 to 50, from 4 to 40 or from 5 to 30.

Examples of suitable nonionic reactive surfactants are available under the references Noigen® RN-10, Noigen® RN-20, Noigen® RN-30, Noigen® RN-40, Noigen® RN-5065, Noigen® KN-10, Noigen® AN 5065, Noigen® AN-30, Noigen® AN-20 and Noigen® AN-10 from Dai-Ichi Kogyo Seiyaku.

The content by weight of the nonionic reactive surfactant, with respect to the weight of the alkyd emulsion, can range from 0% to 5%, preferably from 1% to 4% and more preferentially from 2% to 3%.

According to a particular embodiment, the component b) can comprise an anionic reactive surfactant and a nonionic reactive surfactant. For example, the ratio by weight of the anionic reactive surfactant to the nonionic reactive surfactant can be from 0.5 to 4, preferably from 1 to 3, more preferentially from 1.5 to 2.5.

Besides the reactive surfactant, the component b) can comprise a nonreactive surfactant. The component b) can comprise a mixture of nonreactive surfactants.

Within the meaning of the present invention, a nonreactive surfactant is a surfactant which does not comprise a functional group capable of reacting with a functional group of the alkyd resin, in particular not a polymerizable carbon-carbon double bond.

The nonreactive surfactant can be chosen from an anionic nonreactive surfactant, a nonionic nonreactive surfactant and their mixtures, for example a mixture of an anionic nonreactive surfactant and of a nonionic nonreactive surfactant. Examples of anionic nonreactive surfactants which are preferred comprise, without being limited thereto, an alkyl sulfate, an alkyl ether sulfate, an alkylsulfonate, an alkylbenzenesulfonate, an optionally substituted diphenyl oxide disulfonate, an optionally alkoxylated sulfosuccinate mono- or diester, a phosphonate mono- or diester, a phosphate mono- or diester, and their mixtures. Examples of nonionic nonreactive surfactants which are preferred comprise, without being limited thereto, an optionally alkoxylated fatty alcohol, an optionally alkoxylated fatty acid, an optionally alkoxylated sorbitol ester, an optionally alkoxylated fatty ester, an ethoxy-propoxy block copolymer (EO-PO copolymer) and their mixtures. A list of suitable surfactants is available in the book “Surfactants and Polymers in Aqueous Solutions” (Holmberg et al., 2002, John Wiley & Sons).

Examples of suitable alkyl sulfates and alkyl ether sulfates are optionally ethoxylated C₆-C₂₂ fatty alcohol sulfates, such as decyl sulfate, lauryl sulfate (such as Disponil® SLS), stearyl sulfate or C₁₂-C₁₄ fatty alcohol ether sulfate with from 2 to 50 EO units (such as Disponil® FES 77, Disponil® FES 27, Disponil® FES 993, Disponil® FES 32 or Rhodapex LA 120s).

Examples of suitable alkylsulfonates are C₆-C₂₂ fatty alcohol sulfonates, such as decylsulfonate, laurylsulfonate and stearylsulfonate.

Examples of suitable alkylbenzenesulfonates are benzenesulfonates substituted by a linear or branched C₆-C₂₂ alkyl group, such as sodium dodecylbenzenesulfonate (such as Polystep® A-16-22 or Rhodacal® DS-4).

An example of a suitable diphenyl oxide disulfonate is sodium dodecyl diphenyl oxide disulfonate (such as Dowfax® 2A1 or Calfax® DB45).

Examples of suitable sulfosuccinate mono- or diesters are optionally alkoxylated sulfosuccinic acid mono- or di (C₆-C₂₂) alkyl esters (such as Aerosol® A-102, Aerosol® MA-80 or Aerosol® GPG).

Examples of suitable phosphate mono- or diesters are the compounds of formula (I) or (II) (such as Rhodafac® Rs 410, Rhodafac® Rs 610, Rhodafac® Rs 710, Rhodafac® Rs 960 or Rhodafac® Re 610):

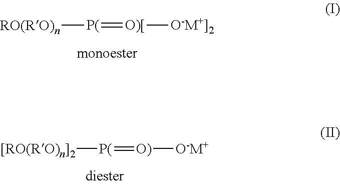

in which:
each R is independently a Ce to C₅₀, preferably Cs to C₃₀, more preferentially C₁₀ to C₂₀, alkyl;
each R′ is independently ethylene or propylene;
n ranges from 2 to 50, preferably from 4 to 40, more preferentially from 8 to 30;
M is chosen from hydrogen, a metal cation (in particular a sodium or potassium cation) or an ammonium.

The phosphate mono- and diesters can in particular be in the form of a mixture, it being possible for the ratio by weight of the phosphate monoester to the phosphate diester to be from 0.8 to 12.

Examples of suitable fatty alcohols are alkoxylated C₆-C₂₂ fatty alcohols with 2 to 50 alkoxy units, such as C₁₂-C₁₄ alcohol ethoxylates (such as Tergitol® 15-S-20), C₁₃ alcohol ethoxylates (such as Emulan® TO 4070 or Emulan® TO 2080), C₁₆-C₁₈ alcohol ethoxylates (such as Empilan® KM80), propoxylated/ethoxylated C₄-C₈ alcohols with a propoxy/ethoxy ratio by weight of the order of 1, ethoxylated (2-40 EO) iso C₁₀ fatty alcohol and ethoxylated (2-40 EO) C₁₀-C₁₈ monobranched fatty alcohols.

Examples of suitable sorbitol esters are C₁₈ sorbitol esters and ethoxylated (5-20 EO units) sorbitol esters.

Examples of suitable fatty acids are ethoxylated (7-100 EO) C₁₂-C₁₈ fatty acids, ethoxylated (30-40 EO) castor oil and ethoxylated (7-60 EO) hydrogenated castor oil.

Examples of suitable fatty esters are glycerol palmitate, glycerol stearate, ethylene glycol stearate, diethylene glycol stearate, propylene glycol stearate, polyethylene glycol 200 stearate (PEG of Mn=200) or ethoxylated (2-15 EO) C₁₈ fatty esters.

Examples of ethoxy-propoxy block copolymers are EO-PO butoxy copolymers (such as Maxemul® 7101).

According to a particular embodiment, the component b) comprises a nonreactive surfactant chosen from optionally ethoxylated C₆-C₂₂ fatty alcohol sulfate, an EO-PO butoxy and mixtures of these.

Preferably, when the reactive surfactant is an anionic surfactant, the component b) can additionally comprise a nonionic nonreactive surfactant. Alternatively, when the reactive surfactant is an nonionic surfactant, the component b) can additionally comprise an anionic nonreactive surfactant.

According to a particular embodiment, the component b) can comprise an anionic reactive surfactant and a nonionic nonreactive surfactant. For example, the ratio by weight of the anionic reactive surfactant to the nonionic nonreactive surfactant can be from 1 to 4, from 2 to 3, preferably from 1.5 to 2.5.

According to an alternative embodiment, the component b) can comprise a nonionic reactive surfactant and an anionic nonreactive surfactant. For example, the ratio by weight of the nonionic reactive surfactant to the anionic nonreactive surfactant can be from 1 to 4, from 2 to 3, preferably from 1.5 to 2.5.

The content by weight of the nonreactive surfactant, with respect to the weight of the alkyd emulsion, varies from 0% to 5%, preferably from 0.5% to 3% and more preferentially from 1% to 2%.

The content by weight of the component b), with respect to the weight of the alkyd emulsion, varies from 1% to 15%, preferably from 2% to 12% and more preferentially from 3% to 10%.

The alkyd emulsion according to the invention can in particular be prepared according to the process described below.

### Process for the Preparation of an Alkyd Emulsion

The invention also relates to a process for the preparation of an alkyd emulsion, the process comprising the following stages:
i) preparation of a component a) comprising an alkyd resin in the molten state;
ii) addition of a component b) comprising a reactive surfactant and water,
iii) neutralization of the acidity of the components a) and b) by addition of a base,
iv) emulsification by phase inversion,
v) optionally adjustment of the solids content of the alkyd emulsion.

The alkyd resin of the component a) can in particular be prepared by polycondensation of an acid component A and of an alcohol component B. The components A and B can in particular be as described above. The components A and B can be heated to a temperature ranging from 80° C. to 250° C. The water formed during the polycondensation can be gradually removed by distillation. The progress of the polycondensation can be monitored by the acid number of the reaction mixture. Once the desired acid number is reached, the alkyd resin can be cooled to ambient temperature (20-30° C.) to be stored for the purpose of subsequent emulsification. Alternatively, the alkyd resin can be directly introduced in the molten state (for example at a temperature of 80° C. to 110° C.) in stage ii) of the process according to the invention.

Stage ii) can be carried out by adding the component b) and water to the reaction medium. The component b) can in particular be as described above. Stage ii) can be carried out at a temperature ranging from 80° C. to 100° C.

Stage iii) can in particular be carried out by addition of a base to the reaction medium. The base can be chosen from LiOH, KOH, NaOH, NH₄OH or a tertiary amine. Stage iii) can be carried out at a temperature ranging from 60° C. to 85° C.

Stage iv) can in particular be carried out by gradually adding water to the reaction mixture with stirring. The temperature of the reaction mixture can be maintained at a temperature ranging from 60° C. to 85° C. Once emulsification is complete, the temperature of the reaction mixture can be left to return to ambient temperature (20° C. to 25° C.).

The optional stage v) can be carried out by adding water to obtain the desired solids content. In particular, the solids content can be adjusted to reach from 35% to 65%, preferably from 40% to 60%, more preferentially from 45% to 55%.

### Composition, Coating and Use

Another subject matter, according to the invention, relates to a coating composition comprising an alkyd emulsion as defined above.

The composition can comprise a drying agent. The drying agent makes it possible to increase the rate of polymerization of the alkyd resin. The drying agents are typically metal salts, in particular cadmium, tin, cobalt, manganese, zirconium, lead, iron or calcium salts, or organic compounds, such as fatty acids.

According to another embodiment, the composition does not comprise a drying agent and dries simply with atmospheric oxygen. It is then sufficient for the aqueous phase to be removed naturally by drying.

The composition according to the invention can be applied to a wide variety of substrates, including wood, metal, stone, plaster, concrete, glass, fabric, leather, paper, a plastic and a composite. Application can be carried out conventionally, in particular with a brush or a roller, by spraying, immersion or covering.

After application of the composition, the water can be removed naturally by drying in the open air, in particular at ambient temperature or by heating.

The composition can in particular be a coating, mastic or adhesive composition.

In particular, the composition can be a coating composition, more particularly a decorative coating composition, in particular a film, paint, varnish, lacquer, stain, adhesion primer or ink composition.

According to a particular embodiment, the composition is a paint, varnish or stain composition, in particular a finishing paint, varnish or stain composition. Such a composition can in particular be applied indoors or outdoors, for example to wood, metal, a wall or plastic.

The composition can in particular be used to obtain a coating (in particular a film, a paint, a varnish, a lacquer, a stain, an adhesion primer or an ink), an adhesive or a mastic.

Another subject matter of the invention relates to the use of the alkyd emulsion according to the invention as binder in order to obtain a coating (in particular a film, a paint, a varnish, a lacquer, a stain, an adhesion primer or an ink), an adhesive or a mastic.

The invention also relates to a coating (in particular a film, a paint, a varnish, a lacquer, a stain, an adhesion primer or an ink), an adhesive or a mastic obtained by application and drying of the composition according to the invention.

The examples which follow illustrate the invention and its performance qualities and do not in any way limit its scope.

### Experimental Part

### Starting Materials

The starting materials used in the examples are described in table 1 below.

TABLE 1

| | | Technical |
|---|---|---|
| Name | Chemical name | function |
| Nouracid ® DE 554 | Dehydrated castor fatty acid | A1 |
| | (mixture of fatty acids containing from | A5 |
| | 40% to 45% of conjugated fatty acid, from | A6 |
| | 9% to 14% of monounsaturated fatty acid | |
| | and from 32% to 40% of nonconjugated | |
| | polyunsaturated fatty acid, by weight with | |
| | respect to the weight of the mixture) | |
| Benzoic acid | Benzoic acid | A3 |
| Pentaerythritol | Pentaerythritol | B1 |
| Phthalic anhydride | Phthalic anhydride | A2 |
| 10% LiOH | Lithium hydroxide | Base |
| | (10% by weight aqueous solution) | |
| Hitenol ® AR 1025 | Ethoxylated styrenated phenyl ether | Anionic reactive |
| | ammonium sulfate of formula | surfactant |
| | 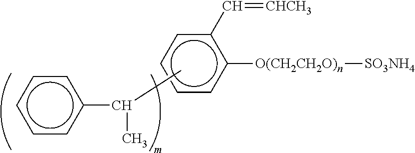 | |
| Emulsogen ® CPA 100 | Phosphated reactive surfactant | Anionic reactive |
| | | surfactant |
| Disponil ® FES 77 | Sodium salt of ethoxylated (30 EO) (C₁₂- | Anionic |
| | C₁₄) alkyl sulfate | nonreactive |
| | | surfactant |
| Noigen ® KN 20 | Ethoxylated 1-(allyloxymethyl) alkyl ether | Nonionic reactive |
| | | surfactant |
| Borchi ® OXY-Coat 1101 | Iron salt | Drying agent |

### Tests and Measurement Methods

These tests and methods are valid in general for the characteristics mentioned in the description and in particular in the examples presented.

### Solids Content

Evaluation following ISO 3251:2008 according to the conditions: 1 g of dispersion for 1 hour at 125° C. and the result is expressed in %.

### Noury Viscosity

The Noury viscosity of the alkyd resin is measured at 110° C. according to the standard AFNOR XP T51-213 (1995) and expressed in mPa·s.

### Brookfield Viscosity

The Brookfield viscosity of the alkyd emulsion is measured at 23° C., 10 rpm, using the 2 and 3 spindles on a Brookfield RVDVE-230 viscometer according to the standard ISO 2555:2018.

### Size of the Particles

The size of the particles of the alkyd emulsion is measured using an item of equipment of Zetasizer-Malvern Instruments Ltd type. The dispersion sample is diluted in a transparent vessel using filtered deionized water. The volume-average size of the particles (Dv50) is measured by 90° laser scattering.

### Acid Number and Hydroxyl Number

The acid number of the alkyd resin is evaluated according to the standard ISO 3682:1996. The hydroxyl number of the alkyd resin is evaluated according to the standard NFT 4326:2019.

### Stability on Storage

The stability on storage corresponds to the variation in the solids content of the alkyd emulsion at 50° C. for 1 month. The stability on storage consists in measuring the solids content at the surface of the sample and in comparing it with the solids content measured at the bottom of the sample. If, after one month of storage at 50° C., the difference in solids content measured is not greater than 2%, the stability is regarded as good.

### Water Resistance

The water resistance of a coating is measured on films having a thickness of 150 μm obtained by application of a formulation using a film applicator on a Leneta P121-10N panel and drying for 24 h at 23° C. (+/−2° C.) with a humidity of 50%. After drying, drops of water are deposited at the surface of the paint film. As many drops of water will be deposited as contact times (for example: 5 min, 15 min, 30 min, 1 h, 2 h, 4 h, 8 h, 16 h, indeed even 24 h) have been chosen. These drops can be covered (with a watch glass, bottle cap, and the like) and/or be deposited on a small piece of filter paper in order to slow down the evaporation (recommended for long contact times). After the chosen contact time has elapsed, gently remove the drop with absorbent paper and evaluate the condition of the test surface. A grading will be carried out immediately after the withdrawal of the drop of water. A second grading will be carried out after having reconditioned the test specimen for 24 h in a room climate-controlled at 23° C. and 50% RH, this being done in order to evaluate the ability of the coating to regain its initial appearance. The water resistance is evaluated qualitatively according to the following scale:
4: No visible change
3: Slight change in gloss visible when the light source is reflected on the test surface/swelling of the coating/variation in coloring (bleaching)/softening of the coating
2: Appearance of a modification to the structure of the coating (slight blistering, crumpling)
1: Significant modification to the structure of the coating (intense blistering)

### Hardness

The hardness of the coating is measured on films having a thickness of 100 μm obtained according to the method described in the measurement of the water resistance. The pendulum is cleaned with acetone. The film is placed under the pendulum. The pendulum is gently brought to the surface of the film. The pendulum is diverted, without laterally moving the pivot, up to the appropriate angle (i.e. 12° for the Persoz pendulum) and temporarily locked with a rod. The counter is reset to zero and the pendulum is released. The measurement is finished when the pendulum is stationary and the counter is no longer increasing. The value is recorded. Three measurements are made on each film and the three values are averaged.

### Example 1 (According to the Invention)

### 1.1) Synthesis of the Alkyd Resin

Into a 1.5 liter reactor comprising:
a dip pipe for the introduction of nitrogen,
a temperature probe,
a reflux condenser supplied with water at 12° C., and
a round-bottomed flask for recovering the water resulting from the polycondensation,
   were introduced the following starting materials:
345.5 g of Nouracid® DE554,
241.2 g of pentaerythritol,
263.1 g of phthalic anhydride and
150.2 g of benzoic acid.

While bubbling nitrogen through it, the combined mixture was brought to 240° C. using an electric heating mantle and the water formed was distilled as it was formed until an acid number of less than 11 mg KOH/g was obtained. At the end of the synthesis, a viscous alkyd resin exhibiting the following characteristics was obtained:
Acid number: 10.9 mg KOH/g
Solids content: 100%-
Noury viscosity: 10 900 mPa·s

### 1.2) Emulsification of the Alkyd Resin in Order to Obtain an Alkyd Emulsion

477.1 g of alkyd resin obtained according to the operating conditions of 1.1) described above, melted beforehand to 80-100° C., were introduced into a 1 liter reactor. When the temperature of the reactor was stabilized at 85° C., 94.4 g of Hitenol® AR 1025 (25% by weight aqueous solution) were introduced. The mixture was left stirring for 30 minutes. 35.66 g of LiOH (10% by weight aqueous solution) were subsequently introduced over a period of time of 30 minutes in order to neutralize the alkyd resin. The mixture was left stirring at 85° C. for 30 minutes. Finally, 375.22 g of water were introduced over a period of time of 2 hours, while maintaining the temperature at 80° C. The reactor was subsequently cooled to ambient temperature and the solids content adjusted to 50%. In the end, an alkyd emulsion was obtained which exhibits the following characteristics:
Solids content: 50%-
pH: 7.5
Brookfield viscosity at 23° C.: <100 mPa·s
Size of the particles: <200 nm
Stability on storage: good

### Example 2 (According to the Invention)

Example 1 was repeated, Hitenol® AR 1025 being replaced with an equivalent amount by weight of Emulsogen® CPA 100. At a comparable solids content, an alkyd emulsion was obtained of similar quality (particle size, pH, viscosity, stability on storage) to that obtained during example 1.

### Example 3 (According to the Invention)

Example 1 was repeated, Hitenol® AR 1025 being replaced with an equivalent amount by weight of a mixture of Hitenol® AR 1025 and of Noigen® KN 20 (2/1 ratio by weight). At a comparable solids content, an alkyd emulsion was obtained of similar quality (particle size, pH, viscosity, stability on storage) to that obtained during example 1.

### Example 4 (Comparative)

Example 1 was repeated, Hitenol® AR 1025 being replaced with an equivalent amount by weight of Disponil® FES 77. At a comparable solids content, an alkyd emulsion was obtained of similar quality (particle size, pH, viscosity, stability on storage) to that obtained during example 1.

### Formulation

150 g of the alkyd emulsion of examples 1 to 4 were introduced into a 250 ml beaker. 0.5% by weight of Borchi® OXY-Coat 1101, with respect to the weight of the solids content of the emulsion, was subsequently added with vigorous stirring (600 revolutions/minute) over a period of time of 5 minutes.

The water resistance and the hardness of the varnishes obtained with the formulation are described in detail in table 2.

TABLE 2

| | Alkyd emulsion | | | |
|---|---|---|---|---|
| | Example 1 | Example 2 | Example 3 | Example 4 |
| | (invention) | (invention) | (invention) | (comparative) |
| Water | 4 | 3 | 4 | 0 |
| resistance | | | | |
| Hardness | 120 | N.D. | N.D. | 80 |

The varnishes containing a reactive surfactant exhibit a better water resistance and a better hardness than those of a varnish comprising a nonreactive surfactant.

1. An alkyd emulsion, characterized in that it comprises:
a) an alkyd resin having an oil length of 20% to 50%, the alkyd resin being based on an acid component A and on an alcohol component B, the acid component A comprising a conjugated fatty acid component A1, the component A1 representing at least 5%; of a total weight of the components A and B;
b) a surfactant comprising a reactive surfactant; and
c) water.

2. The alkyd emulsion as claimed in claim 1, characterized in that the conjugated fatty acid results from a modified vegetable oil.

3. The alkyd emulsion as claimed in claim 1, characterized in that the acid component A comprises a polyacid component A2.

4. The alkyd emulsion as claimed in claim 1, characterized in that the acid component A comprises a nonfatty monoacid component A3.

5. The alkyd emulsion as claimed in claim 1, characterized in that the alcohol component B comprises a polyol.

6. The alkyd emulsion as claimed in claim 1, characterized in that a content by weight of the component a), with respect to the weight of the alkyd emulsion, is from 35% to 65%.

7. The alkyd emulsion as claimed in claim 1, characterized in that an acid number of the alkyd resin is less than 25 mg KOH/g.

8. The alkyd emulsion as claimed in claim 1, characterized in that the component b) comprises an anionic reactive surfactant.

9. The alkyd emulsion as claimed in claim 8, characterized in that the anionic reactive surfactant comprises an aromatic ring.

10. The alkyd emulsion as claimed in claim 8, characterized in that the anionic reactive surfactant corresponds to the following formula (Ia): 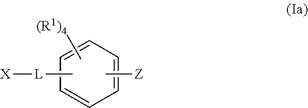
in which:
Z is an ethylenically unsaturated group;
each R¹ is independently chosen from H, alkyl, alkenyl, alkoxy, aryl and alkylaryl;
L is a bond, an alkylene, an oxyalkylene or a polyoxyalkylene;
X comprises a hydrophilic group chosen from —SO₃M, —CO₂M, —P(Y)O₂M, —C(═O)—CH(SO₃M)-CH₂—C(═O)—Y or —C(═O)—CH₂—CH(SO₃M)-C(═O)—Y;
M is H, a metal cation or an ammonium; and
Y is OM or a residue of following formula (Ib):

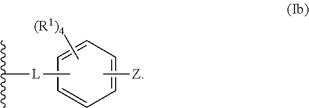

11. The alkyd emulsion as claimed in claim 8, characterized in that the anionic reactive surfactant corresponds to the following formula (Ic): 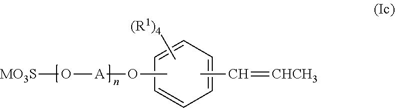
in which each R¹ is independently chosen from H, alkyl, alkenyl, alkoxy, aryl and alkylaryl;
M is H, a metal cation or an ammonium;
each A is independently a C₂-C₄ alkylene; and
n ranges from 1 to 100.

12. The alkyd emulsion as claimed in claim 8, characterized in that the anionic reactive surfactant corresponds to the following formula (Id): 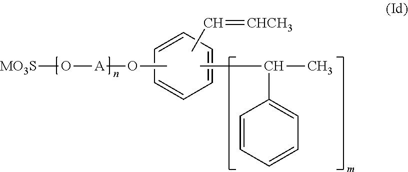
in which M is H, a metal cation or an ammonium;
each A is independently a C₂-C₄ alkylene:
n ranges from 1 to 100; and
m is 1 or 2.

13. The alkyd emulsion as claimed in claim 8, characterized in that a content by weight of the anionic reactive surfactant, with respect to the weight of the alkyd emulsion, is from 0% to 5%.

14. The alkyd emulsion as claimed in claim 1, characterized in that the component b) comprises a nonionic reactive surfactant.

15. The alkyd emulsion as claimed in claim 14, characterized in that a content by weight of the nonionic reactive surfactant, with respect to the weight of the alkyd emulsion, is from 0% to 5%.

16. The alkyd emulsion as claimed in claim 1, characterized in that the component b) comprises an anionic reactive surfactant and a nonionic reactive surfactant, a ratio by weight of the anionic reactive surfactant to the nonionic reactive surfactant ranging from 0.5 to 4.

17. The alkyd emulsion as claimed in claim 1, characterized in that the component b) comprises a nonreactive surfactant.

18. The alkyd emulsion as claimed in claim 17, characterized in that a content by weight of the nonreactive surfactant, with respect to the weight of the alkyd emulsion, is from 0% to 5%.

19. The alkyd emulsion as claimed in claim 1, characterized in that a content by weight of the component b), with respect to the weight of the alkyd emulsion, is from 1% to 15%.

20. A process for the preparation of an alkyd emulsion as defined according to claim 1, characterized in that the process comprises the following stages:
i) preparation of the component a) comprising the alkyd resin in a molten state;
ii) addition of the component b) comprising the reactive surfactant and water,
iii) neutralization of the acidity of the components a) and b) by addition of a base,
iv) emulsification by phase inversion,
v) optionally, adjustment of a solids content of the alkyd emulsion.

21. A composition, characterized in that it comprises an alkyd emulsion as defined according to claim 1.

22. The composition as claimed in claim 21, characterized in that it the composition is a coating, mastic or adhesive composition.

23. (canceled)

24. A coating, an adhesive or a mastic obtained by application and drying of the composition as claimed in claim 21.
